(19) United States
(12) Patent Application Publication
(10) Pub. No.: US 2016/0322839 A1
(43) Pub. Date: Nov. 3, 2016

(54) COMPACT BATTERY PACK WITH DISTRIBUTED BATTERY MANAGEMENT SYSTEM

(71) Applicant: American Lithium Energy Corporation, Vista, CA (US)

(72) Inventor: Jiang Fan, San Diego, CA (US)

(21) Appl. No.: 15/143,255

(22) Filed: Apr. 29, 2016

Related U.S. Application Data
(60) Provisional application No. 62/154,588, filed on Apr. 29, 2015.

(51) Int. Cl. H02J 7/00

(52) U.S. Cl. CPC H02J 7/0026; H02J 7/0021; H02J 7/0014

(57) ABSTRACT

A distributed battery management system manages a battery pack having a first subset of battery cells and a second subset of battery cells. The distributed battery management system includes a first battery management node associated with the first subset of battery cells. The first battery management node is configured to perform operations comprising: receiving, from at least one sensor, one or more measurements with respect to at least one of a plurality of battery cells within the first subset of battery cells; determining, based at least in part on the one or more measurements, that the first subset of battery cells is to be disconnected; and in response to determining to disconnect the first subset of battery cells, disconnecting the first subset of battery cells from the second subset of battery cells.

### RELATED APPLICATION

This application claims priority under 35 U.S.C. §119(e) to U.S. Provisional Patent Application No. 62/154,588, entitled ROBUST BATTERY PACK WITH POWER REDUNDANCY MOUNTED ONTO PRINTED WIRING BOARD and filed on Apr. 29, 2015, the disclosure of which is incorporated herein by reference in its entirety.

### TECHNICAL FIELD

The subject matter described herein relates generally to portable power sources and more specifically to battery packs.

### RELATED ART

A battery pack is an ensemble of individual battery cells connected (e.g., in series and/or parallel) to function as a single battery. Although the performance of the battery pack as a whole may be superior to that of individual battery cells, the inclusion of multiple battery cells also compounds the various hazards (e.g., chemical, electrical, fire) associated with the battery pack. In particular, each battery cell in a conventional battery pack can act as a single point of failure capable of disrupting the operation of the entire battery pack. However, the introduction of safety mechanisms (e.g., battery management system) tends to increase the bulk and weight of the battery pack.

### SUMMARY

Systems, methods, and articles of manufacture, including battery packs, are provided. Implementations of the current subject matter improve the reliability of battery packs including by providing a distributed battery management system for regulating the voltage and energy distribution amongst a plurality of battery cells. Implementations of the current subject matter further improve the portability of battery packs including by realizing the interconnections amongst the plurality of battery cells and the distributed battery management system on a printed circuit board.

Implementations of the current subject matter include a distributed battery management system for managing a battery pack having a first subset and a second subset of battery cells. The system can include a first battery management node associated with the first subset of battery cells. The first battery management node can include one or more processors configured to perform operations that include: receiving, from at least one sensor, one or more measurements with respect to at least one of a plurality of battery cells within the first subset of battery cells; determining, based at least in part on the one or more measurements, that the first subset of battery cells is to be disconnected; and in response to determining to disconnect the first subset of battery cells, disconnecting the first subset of battery cells from the second subset of battery cells.

Implementations of the current subject matter include a method for distributed management of a battery pack having a first subset and a second subset of battery cells. The method can include: receiving, from at least one sensor, one or more measurements with respect to at least one of a plurality of battery cells within the first subset of battery cells; determining, based at least in part on the one or more measurements, that the first subset of battery cells is to be disconnected; and in response to determining to disconnect the first subset of battery cells, disconnecting the first subset of battery cells from at least the second subset of battery cells

Implementations of the current subject matter include a battery pack. The battery pack can include a first subset of battery cells, a second subset of battery cells, a distributed battery management system, and a printed circuit board.

The distributed battery management system can include at least one sensor and a first battery management node. The at least one sensor can be configured to take measurements with respect to a plurality of battery cells within the first subset of battery cells. The first battery management node can be configured to perform operations that include: receiving, from the at least one sensor, one or more measurements with respect to at least one of the plurality of battery cells within the first subset of battery cells; determining, based at least in part on the one or more measurements, that the first subset of battery cells is to be disconnected; and in response to determining to disconnect the first subset of battery cells, disconnecting the first subset of battery cells from the second subset of battery cells.

The printed circuit board can be adapted to provide a plurality of interconnections amongst the first subset of battery cells, the second subset of battery cells, and the distributed battery management system.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to radiation therapy, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an exploded view of a battery pack consistent with implementations of the current subject matter;

FIG. 2 depicts an exploded view of a battery pack consistent with implementations of the current subject matter;

FIG. 3 depicts a perspective view of a battery pack consistent with implementations of the current subject matter;

FIG. 4 depicts a perspective view of a battery pack consistent with implementations of the current subject matter;

FIG. 5 depicts a perspective view of a battery pack consistent with implementations of the current subject matter;

FIG. 6 depicts a plan view of a side of a printed circuit board consistent with implementations of the current subject matter;

FIG. 7 depicts a plan view of a side of a printed circuit board consistent with implementations of the current subject matter;

FIG. 8 depicts a plan view of a side of a printed circuit board consistent with implementations of the current subject matter;

FIG. 9 depicts a plan view of a side of a printed circuit board consistent with implementations of the current subject matter;

FIG. 10 depicts a plan view of a side of a printed circuit board consistent with implementations of the current subject matter;

FIG. 11 depicts a plan view of a side of a printed circuit board consistent with implementations of the current subject matter;

FIG. 12 depicts a plan view of a side of a printed circuit board consistent with implementations of the current subject matter;

FIG. 13 depicts a plan view of a side of a printed circuit board consistent with implementations of the current subject matter;

FIG. 14 depicts a perspective view of a side of a printed circuit board consistent with implementations of the current subject matter;

FIG. 15 depicts a perspective view of a side of a printed circuit board consistent with implementations of the current subject matter;

FIG. 16 depicts a perspective view of a printed circuit board consistent with implementations of the current subject matter;

FIG. 17 depicts a perspective view of a battery pack case consistent with implementations of the current subject matter;

FIG. 18 depicts a perspective view of a battery pack case consistent with implementations of the current subject matter;

FIG. 19 depicts a perspective view of a printed circuit board consistent with implementations of the current subject matter;

FIG. 20 depicts a perspective view of an enlarged fragment of a printed circuit board consistent with implementations of the current subject matter;

FIG. 21A depicts a perspective view of a battery cell consistent with implementations of the current subject matter;

FIG. 21B depicts a perspective view an enlarged fragment of a printed circuit board consistent with implementations of the current subject matter;

FIG. 21C depicts an attachment of a battery cell to a printed circuit board consistent with implementations of the current subject matter;

FIG. 21D depicts an attachment of a battery cell to a printed circuit board consistent with implementations of the current subject matter;

FIG. 22 depicts a perspective view of a battery pack consistent with implementation of the current subject matter;

FIG. 23 depicts a flowchart illustrating a process for battery management consistent with implementations of the current subject matter; and

FIG. 24 depicts a flowchart illustrating a process for battery management consistent with implementations of the current subject matter.

### DETAILED DESCRIPTION

A battery pack includes battery cells of varying capacity. Specifically, some battery cells in the battery pack can have less capacity and are therefore weaker than other battery cells in the battery pack. Weaker battery cells charge and discharge more rapidly than their stronger counterparts. Thus, the weaker battery cells can overcharge and overheat before the stronger battery cells are fully charged. Conversely, the stronger battery cells will continue to discharge and subject the weaker battery cells to a discharge current even after the weaker battery cells are fully discharged. This condition can push the weaker battery cells into reverse polarity and cause irreversible damage (e.g., permanent electrical short) to the battery pack. As such, the charge and discharge of the battery pack require regulation (e.g., peak voltage, energy distribution) at the level of individual battery cells in order to optimize the power, energy, reliability, cycle, and safety of the battery pack.

However, the introduction of a battery management system, particularly at the individual battery cell level, can add significant bulk and weight to a battery pack. For example, in a typical battery pack, individual battery cells are connected in parallel to form pairs of battery cells while multiple pairs of battery cells are further connected in series to form subsets of battery cells. To arrange 24 battery cells in this manner, a conventional battery pack can require over 70 wires for the connections between the individual battery cells and the battery management system. The bulk and weight of these wires renders the conventional battery pack undesirable for conformal and/or wearable applications.

Various implementations of the current subject matter can include systems, methods, and articles of manufacture for a distributed battery management system that increases the reliability of a battery pack by controlling the charge and discharge of a battery pack at the level of individual battery cells. The distributed battery management system can include one or more sensors (e.g., temperature, voltage) at each battery cell and a plurality of battery management nodes. Each battery management node can be configured to control the charge and discharge of battery cells in a corresponding subset of battery cells based on measurements from the one or more sensors at each battery cell. In some implementations of the current subject matter, the distributed battery management system can further include a battery management hub configured to coordinate the charge and discharge of the battery pack across the subsets of battery cells.

In some implementations of the current subject matter, the interconnections between individual battery cells and the distributed battery management system can be realized on a printed circuit board. As such, a battery pack consistent with some implementations of the current subject matter can eliminate the undesirable bulk and weight of a multitude of conventional wire connections. A battery pack consistent with some implementations of the current subject matter can be suitable for applications that require high battery performance and reliability but also impose strict weight and/or space constraints. For example, some implementations of the current subject matter can provide for a conformal and/or wearable battery pack that is compact, lightweight, and reliable.

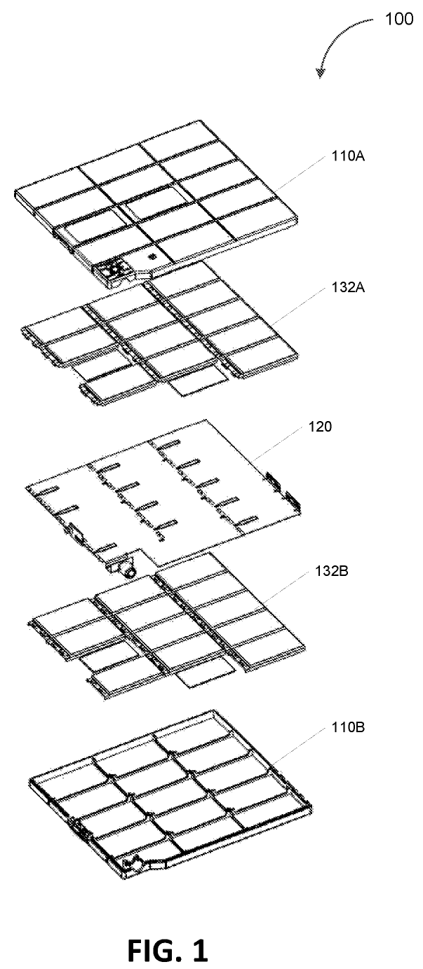

FIG. 1 depicts an exploded view of a battery pack 100 consistent with implementations of the current subject matter. Referring to FIG. 1, the battery pack 100 can include a first half 110A and a second half 110B of a battery pack case 110. For example, in some implementations consistent with the current subject matter, the first half 110A of the battery pack case 110 can be a top half of the battery pack case 110 while the second half 110B of the battery pack case 110 can be a bottom half of the battery pack case 110.

The battery pack case 110 (e.g., the first half 110A and the second half 110B) is adapted to house a printed circuit board 120 and a plurality of individual battery cells. The plurality of battery cells can include a first group 132 of battery cells and a second group 134 of battery cells. As shown in FIG. 1, the first group 132 of battery cells can be disposed on one side (e.g., top) of the printed circuit board 120 and covered by the first half 110A of the battery pack case 110. Meanwhile, the second group 134 of the battery cells can be disposed on a reverse side (e.g., bottom) of the printed circuit board 120 and covered by a second half 110B of the battery pack case 110.

In some implementations consistent with the current subject matter, one or more of the battery pack case 110 (e.g., the first half 110A and/or the second half 110B) and printed circuit board 120 can be constructed from substantially flexible material(s). As such, the battery pack 100 can be a conformal battery pack that is flexible and able to adjust to different contours. For example, in some implementations consistent with the current subject matter, the battery pack 100 can be integrated into a belt or a protective vest.

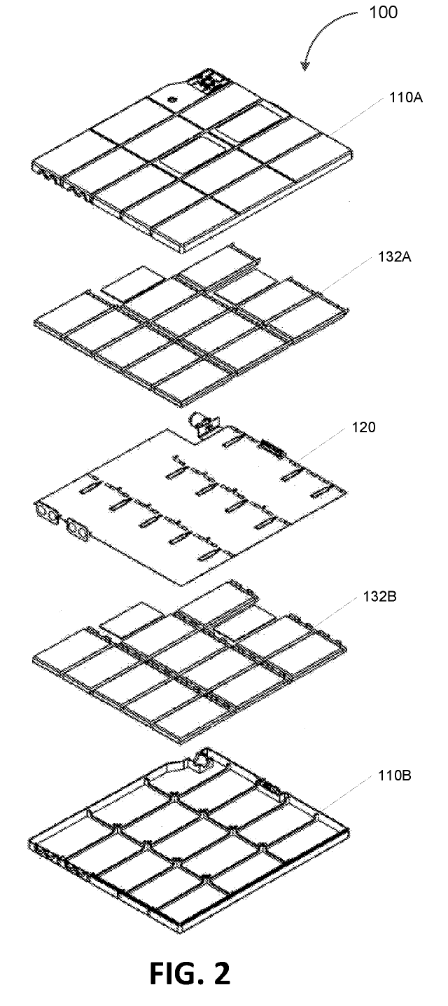

FIG. 2 depicts an exploded view of the battery pack 100 consistent with implementations of the current subject matter. Referring to FIGS. 1-2, the battery pack 100 including the battery pack case 110 (e.g., the first half 110A and the second half 110B), the printed circuit board 120, and the plurality of battery cells (e.g., the first group 132 and the second group 130) shown in FIG. 1 are rotated 180° along a vertical axis (e.g., y-axis) in FIG. 2.

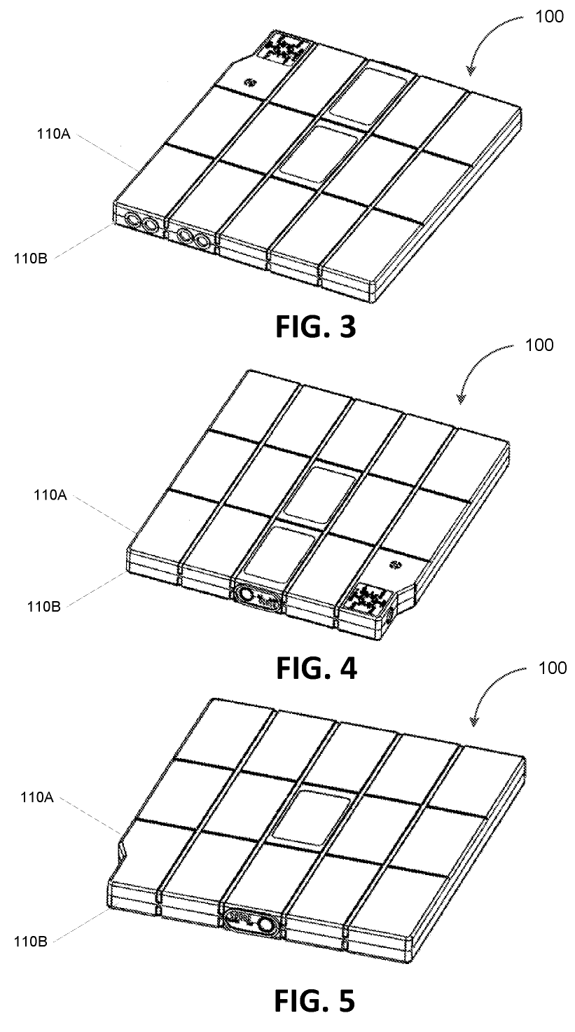

FIG. 3 depicts a perspective view of the battery pack 100 consistent with implementations of the current subject matter. Referring to FIGS. 1-3, the battery pack 100 is shown with the battery pack case 110 (e.g., the first half 110A and the second half 110B) encasing the printed circuit board 120 and the plurality of battery cells (e.g., the first group 132 and the second group 130). FIG. 3 depicts one side (e.g., top) of the battery pack 100.

FIG. 4 depicts a perspective view of the battery pack 100 consistent with the implementations of the current subject matter. Referring to FIGS. 1-4, the battery pack 100 is shown with the battery pack case 110 (e.g., the first half 110A and the second half 110B) encasing the printed circuit board 120 and the plurality of battery cells (e.g., the first group 132 and the second group 130). As shown in FIG. 4, the battery pack 100 shown in FIG. 3 is rotated 180° along a horizontal axis (e.g., x-axis). Thus, FIG. 4 depicts a reverse side (e.g., bottom) of the battery pack.

FIG. 5 depicts a perspective view of the battery pack 100 consistent with implementations of the current subject matter. Referring to FIGS. 1-3 and 5, the battery pack 100 is shown with the battery pack case 110 (e.g., the first half 110A and the second half 110B) encasing the printed circuit board 120 and the plurality of battery cells (e.g., the first group 132 and the second group 130). FIG. 5 shows the battery pack 100 shown in FIG. 3 rotated 180° along a vertical axis (e.g., y-axis).

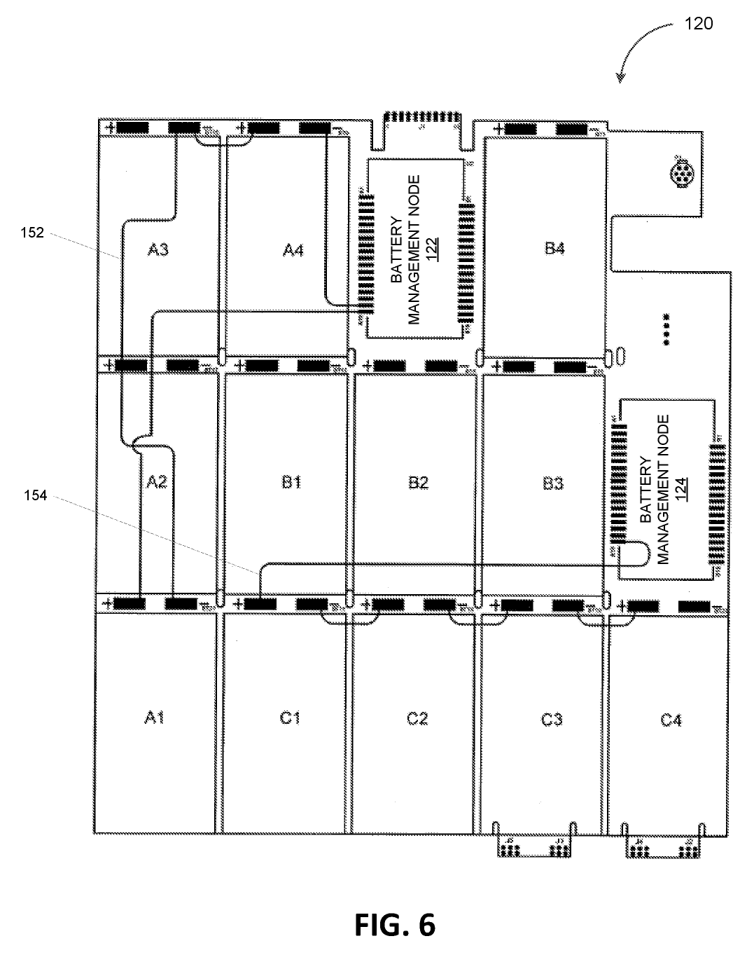

FIG. 6 depicts a plan view of a side of the printed circuit board 120 consistent with implementations of the current subject matter. Referring to FIGS. 1-2 and 6, one side (e.g., top) of the printed circuit board 120 can be adapted to accommodate a plurality of battery cells. The one side of the printed circuit board 120 can be further adapted to accommodate one or more battery management nodes of the distributed battery management system including, for example, a first battery management node 122 and a second battery management node 124. The first battery management node 122 and/or the second battery management node 124 can include, for example, a microprocessor and/or a microcontroller. Alternately or additionally, the first battery management node 122 and/or the second battery management node can include one or more of battery chips (e.g., Texas Instrument BQ40Z50 or BQ40Z60) other components (e.g., fuel gauge and thermal couple monitors).

The plurality of battery cells are grouped into subsets of battery cells including, for example, subsets A, B, and C. For instance, subset A can include battery cells A1, A2, A3, and A4 (in series). Subset B can include battery cells B1, B2, B3, and B4 (in series). Subset C can include battery cells C1, C2, C3, and C4 (in series). Each subset of battery cells is associated with a battery management node configured to regulate the charge and discharge of individual battery cells in that subset of battery cells. For example, as shown in FIG. 6, the first battery management node 122 can be configured to regulate the charge and discharge of the battery cells A1-A4 of subset A. Meanwhile, the second battery management node 124 can be configured to regulate the charge and discharge of the battery cells C1-C4 of subset C.

In some implementations of the current subject matter, a battery management node (e.g., the first battery management node 122, the second battery management node 124) receives measurements (e.g., temperature, voltage) from one or more sensors at each battery cell in a subset of battery cells. The battery management node can determine, based on the measurements, the status of each battery cell in its corresponding subset of battery cells. For instance, the battery management node can determine the state (e.g., percentage) of charge and/or discharge at each battery cell within its corresponding subset of battery cells. The battery management node can further detect, based on the measurements, failures at one or more battery cells within its corresponding subset of battery cells. The battery management node can stop the charge and/or discharge of individual battery cells within its corresponding subset of battery cells based on the status at each battery cell. Alternately or additionally, the battery management node can shuttle energy between individual battery cells in order to balance the charge amongst the battery cells within its corresponding subset of battery cells.

The battery management node can further determine, based on the measurements from the individual battery cells, a status of the subset of battery cells as a whole. Accordingly, the battery management can determine to disconnect the subset of battery cells from other subsets in the battery pack when one or more battery cells fail, is fully charged, and/or is fully discharged. For example, the battery management node can shut down and/or disconnect a corresponding subset of battery cells if the battery management node detects that the temperature at one or more constituent cells exceeds a threshold (e.g., a specified safe temperature). Alternately or additionally, the battery management node can shut down and/or disconnect the corresponding subset of battery cells if the battery management node detects that the voltage at one or more constituent cells exceeds a threshold (e.g., a specified safe voltage). The battery management node can also shut down the corresponding subset of battery cells if the battery management node detects that a charge and/or discharge current exceed one or more thresholds.

The one side of the printed circuit board 120 can provide a plurality of interconnections (e.g., a first interconnection 152, a second interconnection 154) for connecting the individual battery cells and/or the battery management nodes. In some implementations of the current subject matter, battery cells in a subset of battery cells are connected in a series. As such, as shown in FIG. 6, the printed circuit board 120 may provide interconnections (e.g., the first interconnection 152) to serially connect the battery cells A1-A4 of subset A and the first battery management node 122. The printed circuit board 120 can also provide interconnections (e.g., the interconnection 154) to serially connect the battery cells C1-C4 of subset C and the second battery management node 124.

In some implementations of the current subject matter, the battery cells (e.g., the battery cells A1-A4, B1-B4, and C1-C4) can be lithium ion battery cells. However, the battery pack 100 can include any type of battery cells without departing from the scope of the present disclosure.

Although the printed circuit board 120 is shown to accommodate 12 battery cells and two battery management nodes, the printed circuit board 120 can be adapted to accommodate a different number of battery cells and battery management nodes without departing from the scope of the present disclosure. Moreover, each subset (e.g., subset A, B, and C) of battery cells can include a different number of battery cells without departing from the scope of the present disclosure.

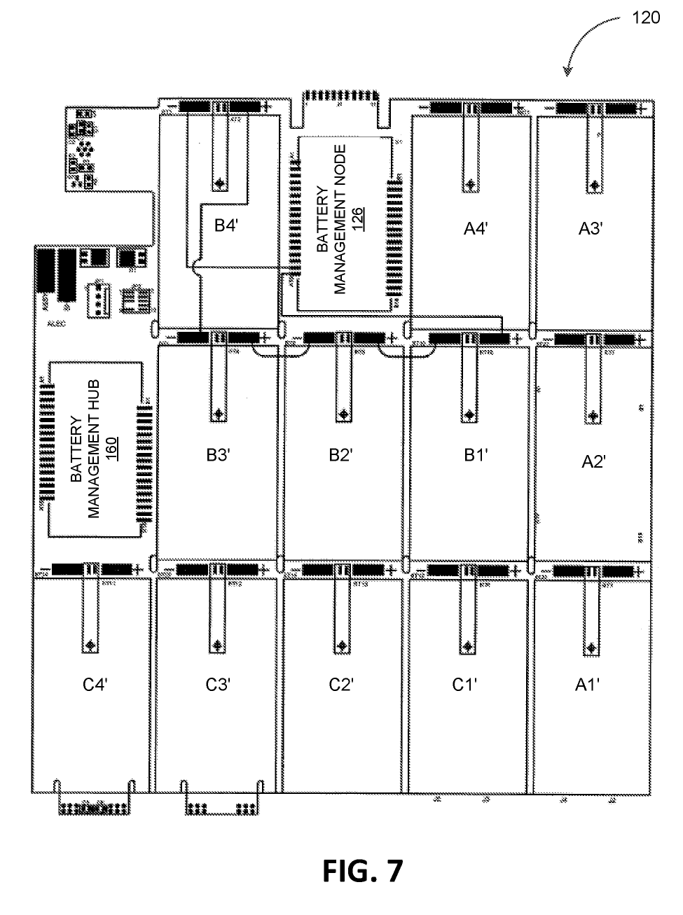

FIG. 7 depicts a plan view of a side of the printed circuit board 120 consistent with implementations of the current subject matter. Referring to FIGS. 1-2 and 6-7, a reverse side (e.g., bottom) of the printed circuit board 120 can be adapted to accommodate additional battery cells and/or battery management nodes. For example, as shown in FIG. 7, the reverse side of the printed circuit board 120 can accommodate battery cells A1′-A4′, and B1′-B4′, and C1′-C4′. The reverse side of the printed circuit board 120 can also accommodate a third battery management node 126 configured to regulate the charge and/or discharge of subset B of battery cells. Alternately or additionally, the reverse side of the printed circuit board 120 can be adapted to accommodate a battery management hub 160 configured to coordinate the charge and discharge of the battery pack 100 and balance the charge of the battery pack 100 across the subsets of battery cells. In some implementations of the current subject matter, the third battery management node 126 and the battery management hub 160 can be microprocessors and/or microcontrollers.

In some implementations of the current subject matter, the battery management hub 160 can be communicatively coupled to the first battery management node 122, the second battery management node 124, and the third battery management node 126. The battery management hub 160 can receive one or more indications of status (e.g., state of charge/discharge, failures) from each of the first battery management node 122, the second battery management node 124, and the third battery management node 126. Based on the indications, the battery management hub 160 can be configured shuttle energy between the subsets (e.g., the subsets A, B, and/or C) of battery cells to balance the charge across the battery pack 100. Moreover, upon indication of a failure at one or more of the subsets (e.g., the subsets A, B, and C) of battery cells, the battery management hub 160 can be configured to adjust the output (e.g., current) from the remaining subsets of battery cells and/or disable the battery pack 100 based on the status (e.g., state of charge and/or discharge) at the remaining subsets of battery cells. In some implementations consistent with the current subject matter, the battery management hub 160 can also be configured to act as the power distributor supplying energy to one or more electronic devices (e.g., radio, night vision goggle). The battery management hub 160 can also be configured to identify an appropriate charger (e.g., smart charger) for charging the battery pack 100.

In some implementations of the current subject matter, battery cells on one side of the printed circuit board 120 (e.g., shown in FIG. 6) are paired with battery cells on the reverse side of the printed circuit board 120. The paired battery cells can be connected in parallel. For example, the reverse side of the printed circuit board 120 can accommodate battery cells A1′-A4′, B1′-B4′, and C1′-C4′. The battery cell A1 on one side of the printed circuit board 120 can be paired and connected in parallel with the battery cell A1′ on the reverse side of the printed circuit board 120. Similarly, the battery cell B1 on one side of the printed circuit board 120 can be paired and connected in parallel with the battery cell B1′ on the reverse side of the printed circuit board 120.

In some implementations consistent with the current subject matter, pairs of battery cells connected in parallel can be further connected to one or more other pairs of battery cells to form subsets of battery cells. The subsets of battery cells are connected in parallel via the battery management hub 160. For example, as shown in FIGS. 6-7, subset A of battery cells can include four pairs battery cells connected in parallel (e.g., A1 and A1′, A2 and A2′, A3 and A3′, and A4 and A4′). Similarly, subset B can also include four pairs of battery cells connected in parallel (e.g., B1 and B1′, B2 and B2′, B3 and B3′, and B4 and B4′). Subsets A, B, and C of battery cells are then connected in parallel via the battery management hub 160.

As shown in FIG. 7, the reverse side of the printed circuit board 120 can provide additional interconnections for connecting individual battery cells, subsets of battery cells, and/or battery management nodes. For example, the printed circuit board 120 can provide interconnections to connect each pair of battery cells (e.g., A1 and A1′, B1 and B′1) in parallel. The printed circuit board 120 can further provide interconnections to serially connect the pairs of battery cells to form subsets of battery cells. The printed circuit board 120 can also provide interconnections to connect each subset of battery cells to a corresponding battery management node. Alternately or additionally, the printed circuit board 120 can provide interconnections to connect subsets A, B, and C in parallel via the battery management hub 160. Arranging the battery cells according to implementations consistent with the current subject matter provides independence between the subsets of battery cells. As such, a single battery cell and/or subset of battery cells cannot act as a single point of failure. That is, failure of one battery cell and/or subset of battery cells do not disable the entire battery pack 100. Instead, the battery pack 100 can remain functional even upon failure at one or more subsets of battery cells (e.g., subsets A, B, and C) and/or one or more battery cells (e.g., A1-A4, A1′-A4′, B1-B4, B1′-B4′, C1-C4, and C1′-C4′).

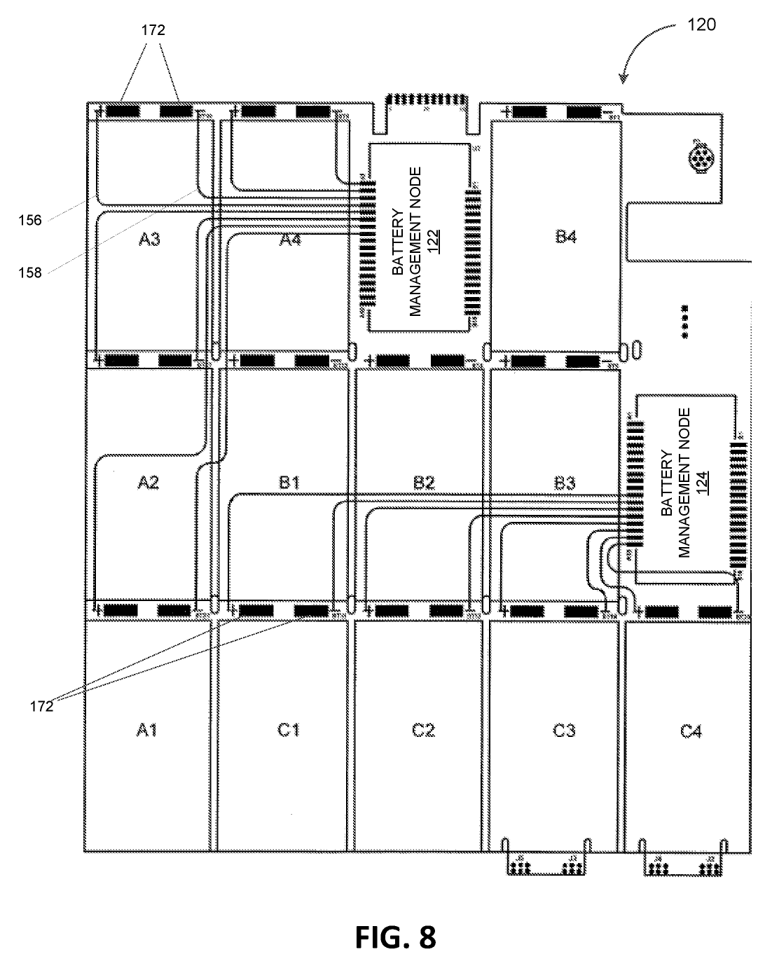

FIG. 8 depicts a plan view of a side of the printed circuit board 120 consistent with implementations of the current subject matter. Referring to FIGS. 1-2, 6, and 8, one side (e.g., top) of the printed circuit board 120 can further accommodate a sensor at each battery cell. For example, the printed circuit board 120 can accommodate a first voltage sensor 172 and a second voltage sensor 174. The first voltage sensor 172 can be configured to measure a voltage at the battery cell A3 while the second voltage sensor 174 can be configured to measure a voltage at the battery cell C1.

As shown in FIG. 8, the printed circuit board 120 can further provide interconnections between the sensors and the corresponding battery management nodes, which can be on a different side of the printed circuit board 120. For example, the printed circuit board 120 can provide interconnections (e.g., a third interconnection 156 and a fourth interconnection 158) between the first voltage sensor 172 of the battery cell A3 and the first battery management node 122. The first battery management node 122 can receive one or more measurements of the voltage at the battery cell A3 from the first voltage sensor 172 via the third interconnection 156 and the fourth interconnection 158. The first battery management node 122 can detect when the battery cell A3 is fully charged and/or discharged based on the voltage measurements from the battery cell A3. The first battery management node 122 can, based on the state of charge and/or discharge at the battery cell A3, stop the charging or discharging of the battery cell A3. The first battery management node 122 can further determine to disconnect subset A from subsets B and C when the battery cell A3 and/or another battery cell is fully charged or discharged. Alternately or additionally, the first battery management node 122 can shuttle energy to and/or from other battery cells (e.g., battery cells A1, A3, and/or A4) in order the balance the charge across the battery cells A1-A4 of the subset A.

Similarly, the printed circuit board 120 can provide interconnections between the second voltage sensor 174 of the battery cell C1 and the second battery management node 124. The second battery management node 124 can receive one or more measurements of the voltage at the battery cell C1 from the second voltage sensor 174 and control the charge and/or discharge of the battery cell C1 based on the voltage measurements from the battery cell A3. For example, the second battery management node 124 can stop the charging and/or discharging of the battery cell C1 when the voltage at the battery cell C1 indicate that the battery cell C1 is fully charged or discharged. The second battery management node 124 can further determine to disconnect subset C from subsets A and B when the battery cell C1 and/or another battery cell is fully charged or discharged. Alternately or additionally, the second battery management node 124 can shuttle energy to and/or from other battery cells (e.g., battery cells C2-C4) in order the balance the charge across the battery cells C1-C4 of the subset C.

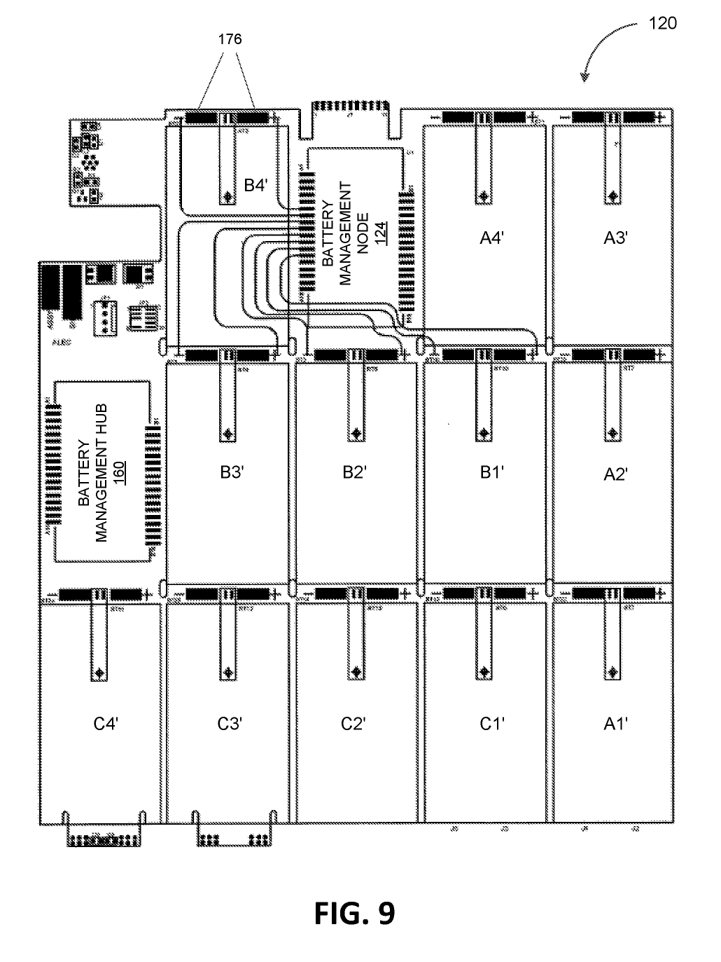

FIG. 9 depicts a plan view of a side of the printed circuit board 120 consistent with implementations of the current subject matter. Referring to FIGS. 1-2, 7, and 9, a reverse side (e.g., bottom) of the printed circuit board 120 can also accommodate one or more sensors (e.g., voltage, temperature) for measuring the state of charge and/or discharge at each individual battery cell. For example, as shown in FIG. 9, the reverse side of the printed circuit board 120 can accommodate a voltage sensor (e.g., a third voltage sensor 176) at each battery cell A1′-A4′, B1′-B4′, and C1′-C4′. The printed circuit board 120 can further provide interconnections between the voltage sensors at each battery cell on the reverse side of the printed circuit board 120 and a corresponding battery management node, which can be on a different side of the printed circuit board 120.

For example, the third battery management node 126 on the reverse side of the printed circuit board 120 can receive, via the interconnections, one or more measurements of voltage at the battery cells B1-B4 and B1′-B4′, and determine a state of charge and/or discharge at each of the battery cells based on the voltage measurements. For example, the third battery management node 126 can be configured to stop the charge or discharge when the voltage measurements indicate that one or more of the battery cells B1-B4 and B1′-B4′ are fully charged and/or discharged. The third battery management node 126 can further determine to disconnect subset B from subsets A and C when one or more of the battery cells B1-B4 and B1′-B4′ are fully charged or discharged. Alternately or additionally, the third battery management node 126 can shuttle energy between the battery cells B1-B4 and B1′-B4′ in order to balance the charge amongst the battery cells of subset B.

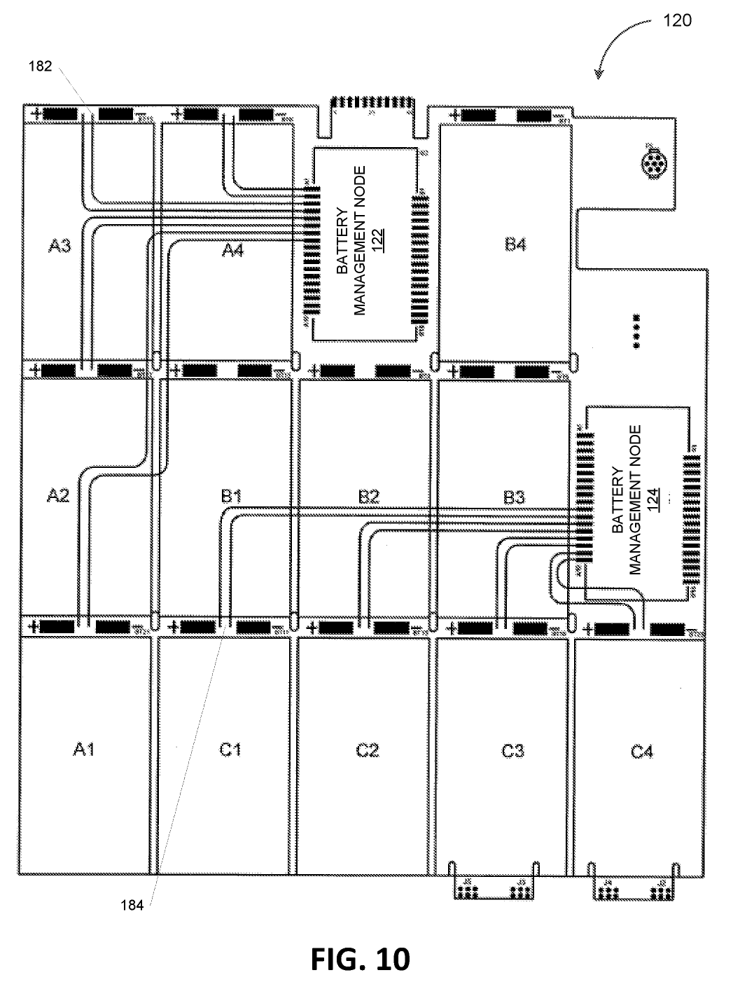

FIG. 10 depicts a plan view of a side of the printed circuit board 120 consistent with implementations of the current subject matter. Referring to FIGS. 1-2, 6, and 10, one side (e.g., top) of the printed circuit board 120 can accommodate one or more additional and/or alternate sensors at each battery cell. For example, in addition to or instead of voltage sensors, the printed circuit board 120 can accommodate a first temperature sensor 182 and a second temperature sensor 184. In some implementations of the current subject matter, the temperature sensors (e.g., the first temperature sensor 182 and the second temperature sensor 184) can be thermal couples. The first temperature sensor 182 can be configured to measure a temperature at the battery cell A3 while the second temperature sensor 184 can be configured to measure a temperature at the battery cell C1.

As shown in FIG. 10, the printed circuit board 120 can further provide interconnections between the sensors and the corresponding battery management nodes, which can be a different side of the printed circuit board 120. For example, the printed circuit board 120 can provide interconnections between the first temperature sensor 182 and the first battery management node 122. The first battery management node 122 can receive one or more measurements of the temperature at the battery cell A3 from the first temperature sensor 182. The temperature measurements indicate to the first battery management node 122 when the battery cell A3 is fully charged. As such, the first battery management node 122 can stop the charging of the battery cell A3 based on the temperature measurements from the first temperature sensor 182. The first battery management node 122 can further determine to disconnect subset A from subsets B and C when battery cell A3 and/or another battery cell is fully charged or discharged. Alternately or additionally, the first battery management node 122 can shuttle energy between the battery cells A1-A4 in order to balance the charge amongst the battery cells A1-A4.

The printed circuit board 120 can also provide interconnections between the second temperature sensor 184 and the second battery management node 124. The second temperature sensor 184 can provide, via the interconnections, one or more measurements of the temperature at the battery cell C1 to the second battery management node 124. The second battery management node 124 can detect when the battery cell C1 is fully charged and stop the charging of the battery cell C1 based on the temperature measurements provided by the second temperature sensor 184. The second battery management node 124 can further determine to disconnect subset C from subsets A and B when battery cell C1 and/or another battery cell is fully charged or discharged. Alternately or additionally, the second battery management node 124 can shuttle energy between the battery cells C1-C4 in order to balance the charge amongst the battery cells C1-C4.

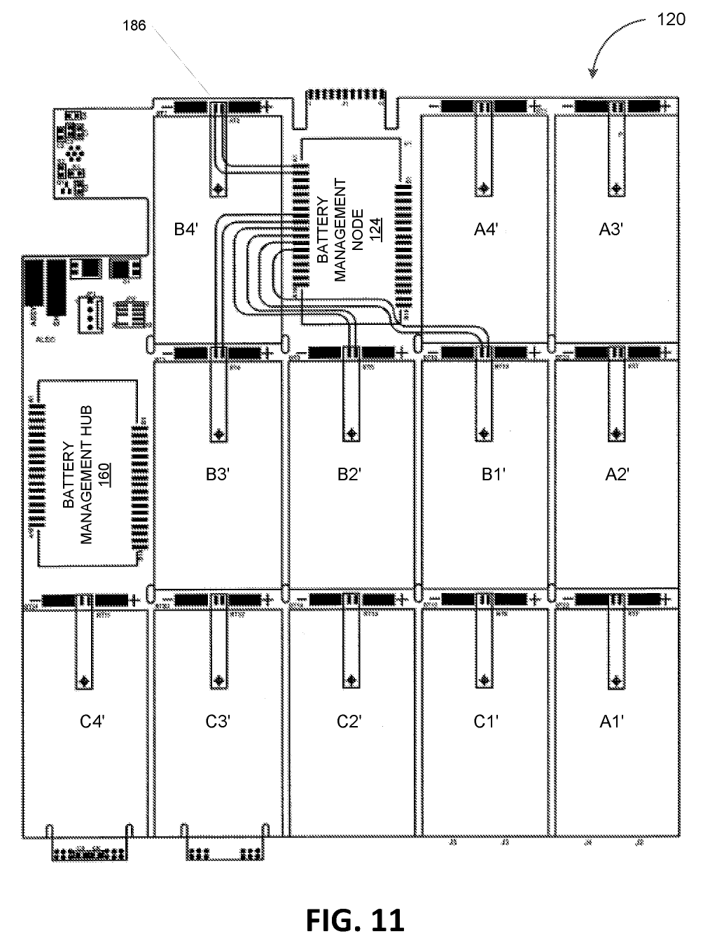

FIG. 11 depicts a plan view of a side of the printed circuit board 120 consistent with implementations of the current subject matter. Referring to FIGS. 1-2, 7, and 11, a reverse side (e.g., bottom) of the printed circuit board 120 can also accommodate additional and/or alternate sensors at each battery cell. As shown in FIG. 11, the reverse side of the printed circuit board 120 can also accommodate a temperature sensor at each battery cell (e.g., the battery cells B1-B4 of subset B) in addition to or instead of voltage sensors. For example, the reverse side of the printed circuit board 120 can accommodate a third temperature sensor 186 for measuring a temperature at the battery cell B4.

The printed circuit board 120 can further provide interconnections between the sensors and the corresponding battery management nodes, which can be on a different side of the printed circuit board 120. For example, the printed circuit board 120 can provide interconnections between the third temperature sensor 186 and the third battery management node 126. The third temperature sensor 186 can provide one or more measurements of the temperature at the battery cell B4 to the third battery management module 126 via the interconnections. The temperature measurements can indicate to the third battery management module 126 when the battery cell B4 is fully charged. As such, the third battery management module 126 can determine when to stop the charging of the battery cell B4 based on the temperature measurements provided by the third temperature sensor 186. The third battery management node 126 can further determine to disconnect subset B from subsets A and C when battery cell B4 and/or another battery cell is fully charged or discharged. Alternately or additionally, the third battery management node 126 can shuttle energy between the battery cells B1-B4 and B1′-B4′ in order to balance the charge amongst the battery cells of subset B.

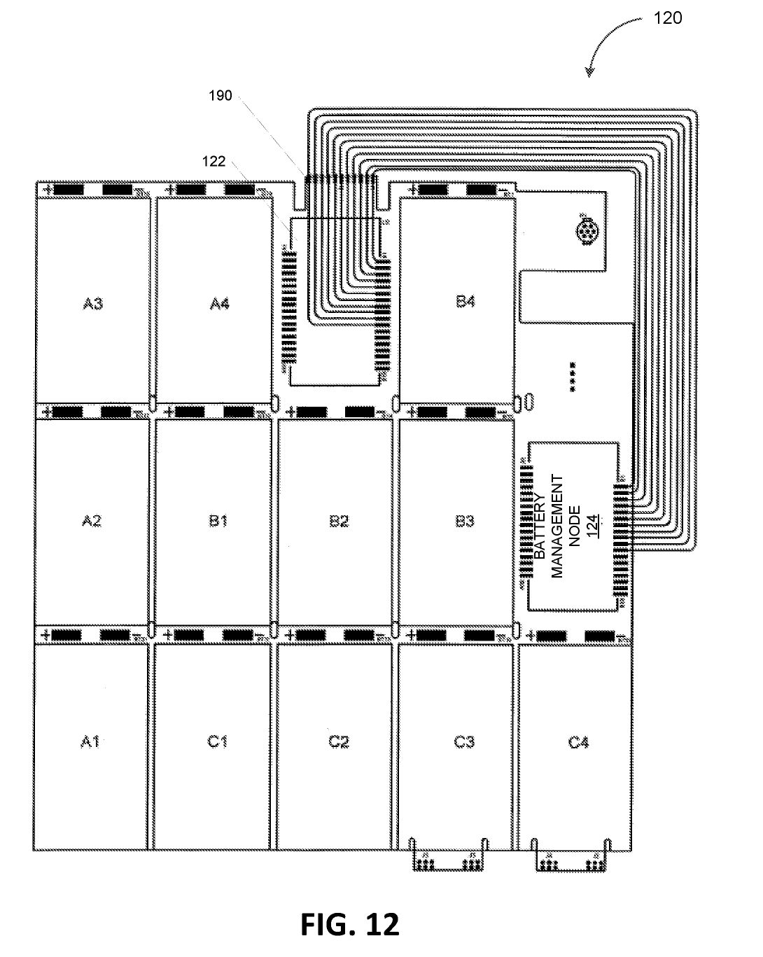

FIG. 12 depicts a plan view of a side of the printed circuit board 120 consistent with various implementations of the current subject matter. Referring to FIGS. 1-2 and 12, the battery pack 120 can include one or more light emitting diodes 190 for providing a status of the battery pack 120 and/or the individual subsets of battery cells (e.g., the subsets A, B, and C). For example, the light emitting diodes 190 can indicate a state (e.g., percentage) of charge and/or discharge of the battery pack 120 and/or of each subset (e.g., subsets A, B, and C) of battery cells. Alternately or additionally, the light emitting diodes 190 can indicate a failure of the battery pack 120 and/or of one or more subsets of battery cells.

As shown in FIG. 12, the printed circuit board 120 can accommodate the light emitting diodes 190. One side of the printed circuit board 120 can further accommodate one or more interconnections between the light emitting diodes 190 and one or more battery management nodes (e.g., the first battery management node 122 and the second battery management node 124). For example, the first battery management node 122 can activate one or more of the light emitting diodes 190 to indicate a status (e.g., state of charge and/or discharge, failures) of subset A of battery cells. Similarly, the second battery management module 124 can activate one or more of the light emitting diodes 190 to indicate a status (e.g., state of charge and/or discharge, failures) of subset C of battery cells.

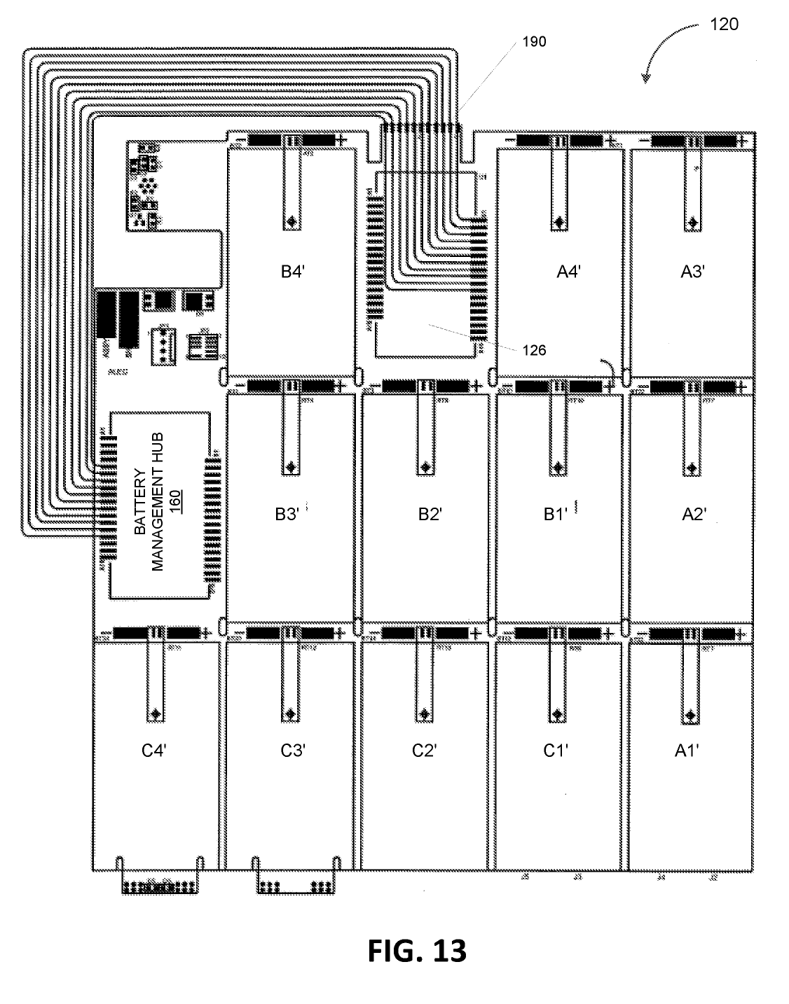

FIG. 13 depicts a plan view of a side of the printed circuit board 120 consistent with implementations of the current subject matter. Referring to FIGS. 1-2 and 12-13, a reverse side of the printed circuit board 120 can provide additional interconnections between the light emitting diodes 190 and the third battery management node 126. For example, in some implementations of the current subject matter, the third battery management module 126 can activate one or more of the light emitting diodes 190 to indicate a status (e.g., state of charge and/or discharge, failures) of the subset B of battery cells.

In some implementations of the current subject matter, the printed circuit board 120 can further provide interconnections between the light emitting diodes 190 and the battery management hub 160. The battery management hub 160 can be configured to coordinate the charge and/or discharge of the battery pack 120 across the subsets of battery cells (e.g., the subsets A, B, and C). For example, the battery management hub 160 can receive indications of the status (e.g., state of charge and/or discharge, failures) of each subset of battery cells (e.g., the subsets A, B, and C) from the first battery management node 122, the second battery management node 124, and the third battery management node 126. The battery management hub 160 can activate one or more of the light emitting diodes 190 to reflect an overall status of the battery pack 100 based on the status of each subset of battery cells.

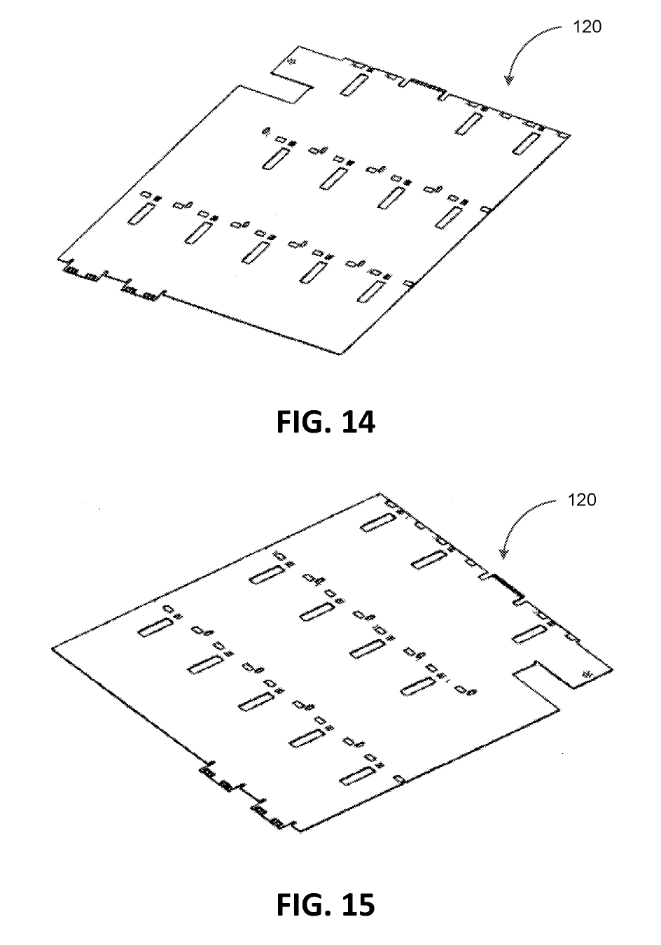

FIG. 14 depicts a perspective view of a side of the printed circuit board 120 consistent with implementations of the current subject matter. The printed circuit board 120 is shown in FIG. 14 without any of the interconnections between the battery cells, sensors (e.g., voltage and/or temperature), and the distributed battery management system (e.g., the first battery management node 122, the second battery management node 124, the third battery management node 126, and the battery management hub 160).

FIG. 15 depicts a perspective view of a side of the printed circuit board 120 consistent with implementations of the current subject matter. As shown in FIG. 15, the printed circuit board 120 shown in FIG. 14 (e.g., absent any interconnections) is rotated 180° along a vertical axis (e.g., y-axis).

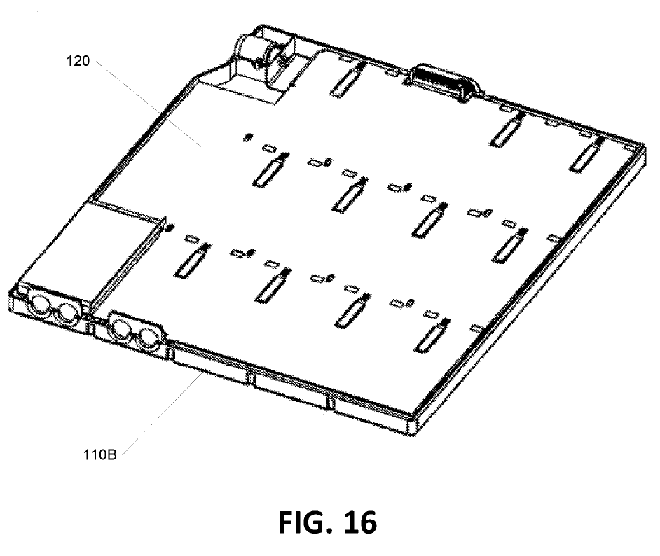

FIG. 16 a perspective view of the printed circuit board 120 consistent with implementations of the current subject matter. The printed circuit board 120 is shown in FIG. 16 without any of the interconnections between the battery cells, sensors (e.g., voltage, temperature), and the distributed battery management system (e.g., the first battery management node 122, the second battery management node 124, the third battery management node 126, and the battery management hub 160). As shown in FIG. 16, the printed circuit board 120 is encased in the second half 110B (e.g., the bottom half) of the battery pack case 110.

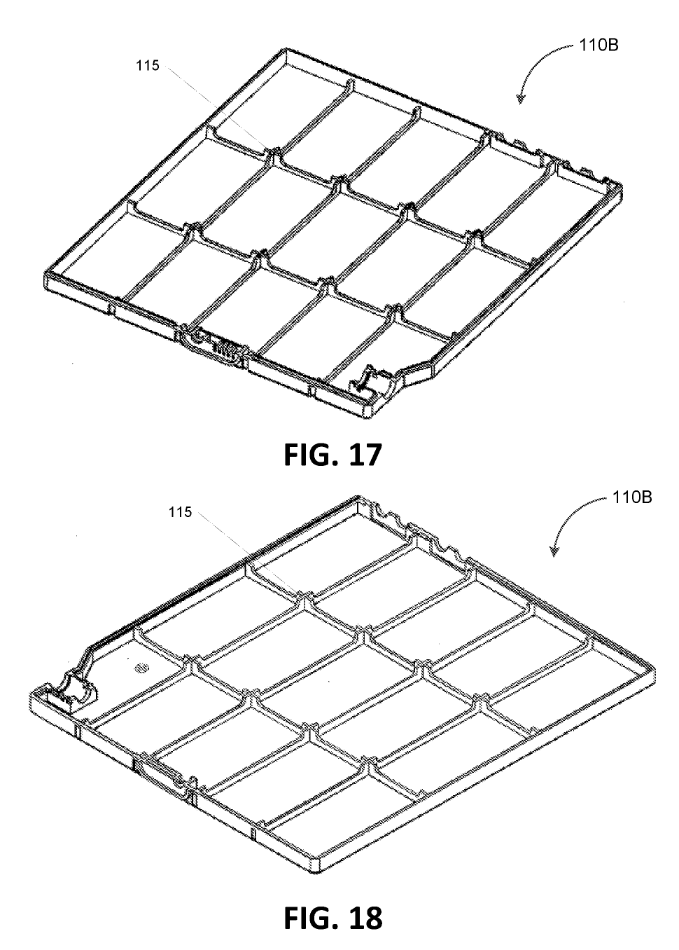

FIG. 17 depicts a perspective view of the battery pack case 110 consistent with implementations of the current subject matter. Referring to FIGS. 1-2 and 17, the second half 110B (e.g., the bottom half) of the battery pack case 110 with a retainer structure 115 adapted to retain the individual battery cells (e.g., the battery cells A1-A4, B1-B4, and/or C1-C4) such that the individual battery cells are aligned with the interconnections provided by the printed circuit board 120. For example, the retainer structure 115 can maintain a position of the battery cell A3 with respect to the first interconnection 152, the third interconnection 156, and the fourth interconnection 158. The retainer structure 115 can also maintain a position of the battery cell C1 with respect to the second interconnection 154. Although not shown, the first half 110A (e.g., the top half) of the battery pack case 110 may or may not have a same or similar retainer structure 115 without departing from the scope of the present disclosure.

FIG. 18 depicts a perspective view of the battery pack case 110 consistent with implementations of the current subject matter. Referring to FIGS. 1-2 and 17-18, the second half 110B (e.g., the bottom half) of the battery pack case 110 is shown with the retainer structure 115. As shown in FIG. 18, the second half 110B of the battery pack case 110 shown in FIG. 17 is rotated 180° around a vertical axis (e.g., y-axis).

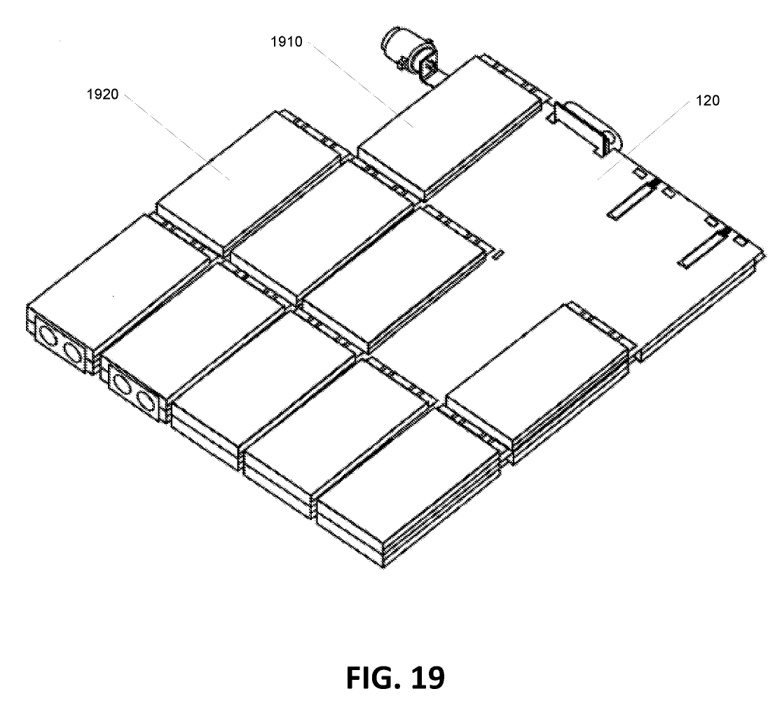

FIG. 19 depicts a perspective view of the printed circuit board 120 consistent with implementations of the current subject matter. As shown in FIG. 19, a plurality of battery cells (e.g., a first battery cell 1910, a second battery cell 1920) can be attached to the printed circuit board 120. Referring to FIGS. 6-13 and 19, one or more of the battery cells A1, A2, B1-B4, and C1-C4 can be attached to the printed circuit board 120 in the manner shown in FIG. 19.

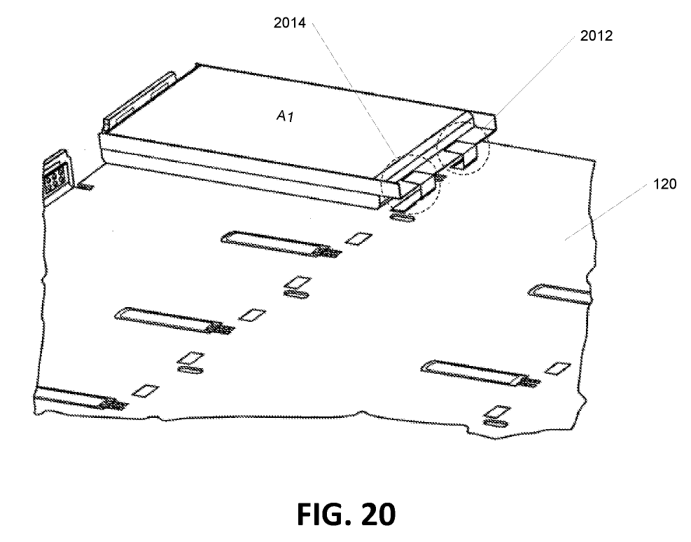

FIG. 20 depicts a perspective view of an enlarged fragment of the printed circuit board 120 consistent with implementations of the current subject matter. Referring to FIG. 20, a battery cell can be secured to the printed circuit board 120 via one or more hook-slot connectors. For example, the battery cell A1 can be secured to the printed circuit board 120 via a first hook-slot connector 2012 and a second hook-slot connector 2014.

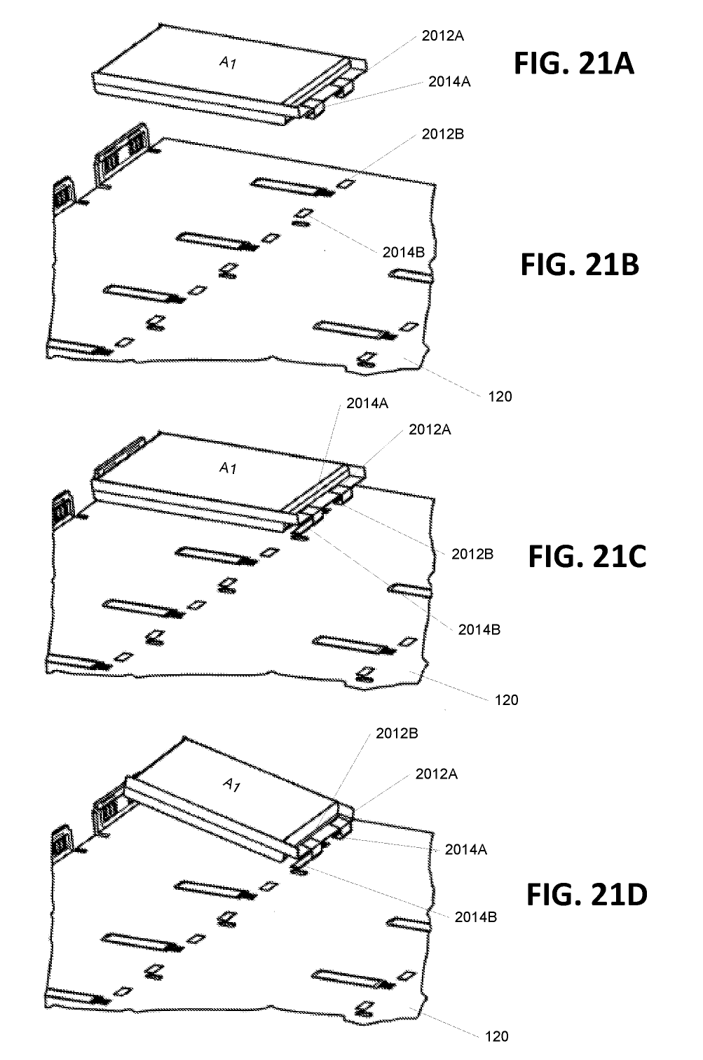

As shown in FIG. 21A, the battery cell A1 can include a first hook 2012A and a second hook 2014A. Meanwhile, FIG. 21B shows that the printed circuit board 120 can include a first slot 2012B and a second slot 2014B. Referring to FIGS. 21C-D, the first battery cell A1 can be secured to the printed circuit board 120 by fastening the first hook 2012A and the second hook 2014A to the first slot 2012B and the second slot 2014B, respectively. A different mechanism to secure individual battery cells to the printed circuit board 120 can be employed without departing from the scope of the present disclosure.

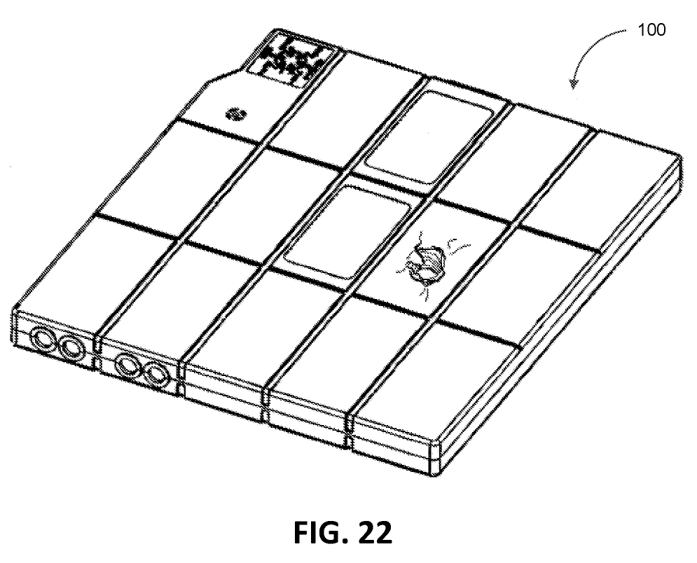

FIG. 22 depicts a perspective view of the battery pack 100 consistent with implementations of the current subject matter. Referring to FIGS. 1-22, one or more battery cells can fail due to damage to a portion of the battery pack 100. In some implementations consistent with the current subject matter, the distributed battery management system prevents one or more individual battery cells from becoming single points of failure. As such, failure of a single battery cell can disable only the corresponding subset of battery cells. For example, when one or more of the battery cells A1-A4 and/or A1′-A4′ fail (e.g., due to damage), the first battery management node 122 can respond to that failure by disconnecting subset A from subsets B and C. The battery management hub 160 can further coordinate the charge and/or discharge of the battery pack 100 across the remaining subsets B and C. Thus, the battery pack 100 can continue to operate with the battery cells even when one or more battery cells have failed.

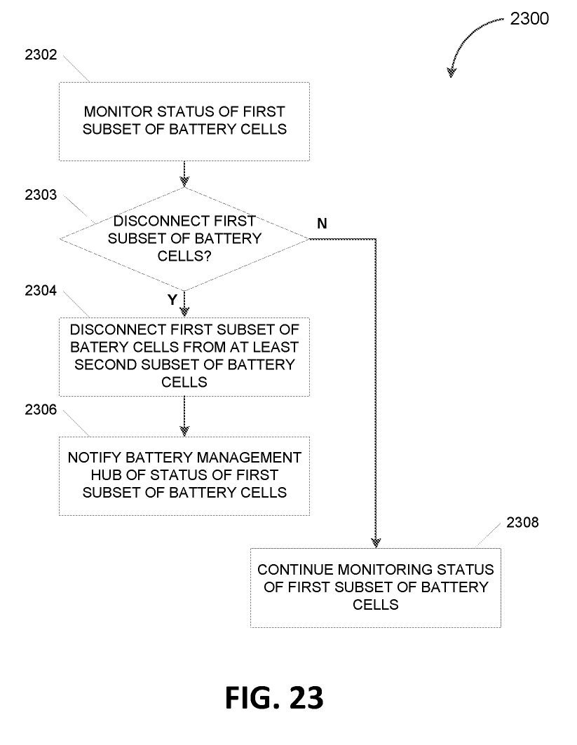

FIG. 23 depicts a flowchart illustrating a process 2300 for battery management consistent with implementations of the current subject matter. Referring to FIGS. 1-23, the process 2300 can be performed by a distributed battery management system (e.g., the first battery management node 122, the second battery management node 124, and/or the third battery management node 126) of the battery pack 100.

A battery management node monitors a status of a first subset of battery cells (2302). In some implementations of the current subject matter, a battery management node can monitor a status of the subset of battery cells based on measurements from one or more sensors at each battery cell in the subset of battery cells. For example, the first battery management node 122 can receive one or more measurements from voltage sensors (e.g., the first voltage sensor 172) and/or temperature sensors (e.g., the first temperature sensor 182) at each of the battery cells A1-A4 and A1′-A4′. The first battery management node 122 can monitor a status of subset A of battery cells based on the measurements from the voltage sensors and/or temperature sensors at each of the battery cells A1-A4 and A1′-A4′. The measurements from the one or more sensors at each battery cell can indicate a state of charge and/or discharge at each of the battery cells. Alternately or additionally, the first battery management node 122 can detect a failure at one or more of the battery cells A1-A4 and A1′-A4′ based on the measurements from the one or more sensors.

The battery management node determines whether to disconnect the first subset of battery cells based on the status of the subset of battery cells (2303). For example, the subset A of battery cells can fail due to damage to one or more of the battery cells A1-A4 and A1′-A4′. Alternately or additionally, the subset A of battery cells can be fully charged and/or discharged. The first battery management node 122 can determine to disconnect the subset A of battery cells when the subset A of battery cells fails and/or is fully charged or discharged.

If the battery management node determines to disconnect the first subset of battery cells (2303-Y), the battery management node disconnects the first subset of battery cells from at least a second subset of battery cells (2304). For example, when the first battery management node 122 detects a failure at subset A (e.g., a failure of one or more of battery cells A1-A4 and A1′-A4′), the first battery management node 122 can disconnect subset A from subsets B and C. Disconnecting subset A from subsets B and C allows the battery pack 100 to continue operation (e.g., charge and/or discharge) with subsets B and C. \

Alternately or additionally, the one or more measurements (e.g., voltage, temperature) from the sensors can indicate that subset A is fully charged or discharged. As such, the first battery management node 122 can disconnect subset A from subsets B and C so that charge and discharge currents to and from subsets B and C can bypass the battery cells A1-A4 and A1′-A4′ of subset A. Disconnecting subset A in this case can prevent subset A from being overcharged and/or pushed into reverse polarity.

When the battery management node determines to disconnect the first subset of battery cells, the battery management node can further notify a battery management hub of the status of the first subset of battery cells (2306). In some implementations of the current subject matter, the battery management hub 160 can be configured to coordinate the charge and/or discharge of the battery pack 100 across the subsets of battery cells. As such, when the first battery management node 122 disconnects subset A from subsets B and C of battery cells, the first battery management node 122 can notify the battery management hub 160 of the disconnection of subset A. The battery management hub 160 can continue to coordinate the charging and/or discharging of the battery pack based on the status of at least the first subset of battery cells and the second subset of battery cells. For example, in some implementations of the current subject matter, when the battery management hub 160 is notified of the disconnection of one or more subsets of battery cells (e.g., subset A), the battery management hub 160 can disable the battery pack 100 and/or adjust an output (e.g., current) from the remaining subsets of battery cells (e.g., subsets B and C) based on the status (e.g., state of charge and/or discharge) of the remaining subsets of battery cells.

Alternately or additionally, if the battery management node determines not to disconnect the first subset of battery cells (2303-N), the battery management node continues to monitor the status of the first subset of battery cells (2308). For example, if the status of subset A of battery cells indicate the subset A is not yet fully charged and/or discharged, the first battery management node 122 can continue to monitor the status of subset A by receiving measurements from the voltage sensors (e.g., the first voltage sensor 172) and/or temperature sensors (e.g., the first temperature sensor 182).

The process 2300 can include different and/or additional operations than shown without departing from a scope of the present disclosure. Moreover, one or more operations of the process 2300 can be repeated and/or omitted without departing from the scope of the present disclosure.

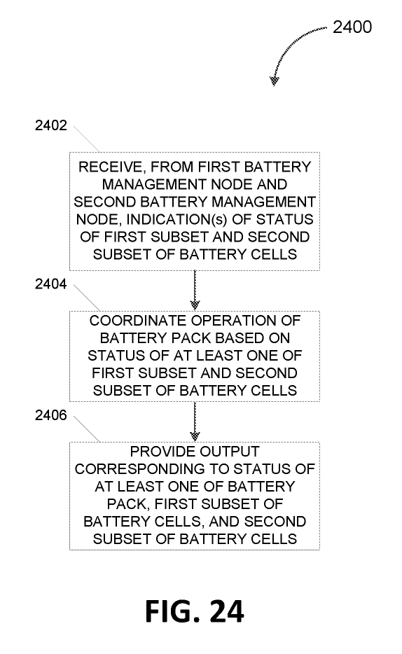

FIG. 24 depicts a flowchart illustrating a process 2400 for battery management consistent with implementations of the current subject matter. Referring to FIGS. 1-24, the process 2400 can be performed by a distributed battery management system (e.g., the battery management hub 160) of the battery pack 100.

A battery management hub receives, from a first battery management node and a second battery management node, one or more indications of a status of first subset of battery cells and a status of a second subset of battery cells (2402). For example, the first battery management node 122 and the second battery management node 124 can be configured to notify the battery management hub 160 of the status (e.g., state of charge and/or discharge, failures) of subsets A and C of battery cells.

The battery management hub coordinates the operation of a battery pack based on the status of at least one of the first subset of battery cells and the second subset of battery cells (2404). In some example implementations of the current subject matter, the battery management hub 160 can coordinate the charge and/or discharge of the battery pack 100 across subsets A, B, and/or C of battery cells. The battery management hub 160 can further balance a charge across subsets A, B, and/or C of battery cells. For instance, upon disconnection of one or more of the subsets A, B, and C (e.g., due to failures, full charge, or full discharge), the battery management hub 160 can increase an output from the remaining subsets of battery cells. Alternately or additionally, when the battery management hub 160 is notified of the disconnection of one or more of the subsets A, B, and C, the battery management hub 160 can disable the battery pack 100.

The battery management hub provides an output corresponding to the status of at least one of a battery pack, the first subset of battery cells, and the second subset of battery cells (2406). For instance, in some example implementations of the current subject matter, the battery management system 160 can activate one or more of the light emitting diodes 190 to provide an indication of the status (e.g., state of charge and/or discharge, failures) of the battery pack 100 and/or any of the constituent subsets of battery cells (e.g., the subsets A, B, and/or C).

The process 2400 can include different and/or additional operations than shown without departing from a scope of the present disclosure. Moreover, one or more operations of the process 2400 can be repeated and/or omitted without departing from the scope of the present disclosure.

Implementations of the present disclosure can include, but are not limited to, methods consistent with the descriptions provided above as well as articles that comprise a tangibly embodied machine-readable medium operable to cause one or more machines (e.g., computers, etc.) to result in operations implementing one or more of the described features. Similarly, computer systems are also described that can include one or more processors and one or more memories coupled to the one or more processors. A memory, which can include a computer-readable storage medium, can include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital MRI image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations can be within the scope of the following claim.

What is claimed is:

1. A distributed battery management system for managing a battery pack having a first subset and a second subset of battery cells, the system comprising:
a first battery management node associated with the first subset of battery cells, wherein the first battery management node comprises one or more processors configured to perform operations comprising:
receiving, from at least one sensor, one or more measurements with respect to at least one of a plurality of battery cells within the first subset of battery cells;
determining, based at least in part on the one or more measurements, that the first subset of battery cells is to be disconnected; and
in response to determining to disconnect the first subset of battery cells, disconnecting the first subset of battery cells from the second subset of battery cells.

2. The system of claim 1, further comprising one or more sensors configured to take measurements with respect to the plurality of battery cells within the first subset of battery cells.

3. The system of claim 2, wherein the measurements include a temperature measurement and/or a voltage measurement.

4. The system of claim 1, wherein the one or more measurements indicate a status of the at least one battery cell.

5. The system of claim 4, wherein the first battery management node is further configured to determine a status of the first subset of battery cells based at least in part on the status of the at least one battery cell.

6. The system of claim 5, further comprising a battery management hub configured to coordinate an operation of the battery pack based at least in part on the status of the first subset of battery cells.

7. The system of claim 6, wherein the coordination of the operation of the battery pack includes:
in response to the disconnection of the first subset of battery cells, adjusting an output of the second subset of battery cells and/or disabling the battery pack.

8. The system of claim 5, wherein the status of the at least one battery cell comprises a state of charge, a state of discharge, and/or failure of the at least one battery cell.

9. The system of claim 8, wherein the first battery management node determines to disconnect the first subset of battery cells when the status of the at least one battery cell comprises one or more of fully charged, fully discharged, and failed.

10. The system of claim 1, further comprising:
a second battery management node associated with the second subset of battery cells, wherein the second battery management node comprises one or more processors configured to perform additional operations comprising:
receiving, from at least one sensor, one or more measurements with respect to at least one of a plurality of battery cells within the second subset of battery cells, wherein the one or more measurements indicate a status of the at least one battery cell; and
determining, based at least in part on the one or more measurements, a status of the second subset of battery cells.

11. The system of claim 1, wherein the second subset of battery cells is configured to continue operation when the first subset of battery cells is disconnected from the second subset of battery cells.

12. A battery pack, comprising:
a plurality of subsets of battery cells; and
the distributed battery management system of claim 1.

13. The battery pack of claim 12, further comprising a printed circuit board adapted to provide a plurality of interconnections amongst at least the distributed battery management system and the plurality of subsets of battery cells.

14. The battery pack of claim 13, wherein the plurality of interconnections includes one or more of: an interconnection connecting a sensor at a battery cell and a battery management node, an interconnection to connect in parallel a pair of battery cells, an interconnection to connect in series two or more pairs of battery cells to form a subset of battery cells, an interconnection to connect a subset of battery cells to a battery management node, and an interconnection to connect two or more subsets battery cells in parallel via a battery management hub.

15. The battery pack of claim 12, further comprising a battery pack case adapted to accommodate the plurality of subsets of battery cells, the printed circuit board, and the distributed battery management system.

16. The battery pack of claim 15, wherein one or more of the battery pack case and the printed circuit board is constructed from a substantially flexible material.

17. The battery pack of claim 12, further comprising one or more light emitting diodes, and wherein the distributed battery management system is further configured to provide a status of one or more subsets of the plurality of subset of battery cells by at least activating the one or more light emitting diodes.

18. A method for distributed management of a battery pack having a first subset and a second subset of battery cells, the method comprising:
receiving, from at least one sensor, one or more measurements with respect to at least one of a plurality of battery cells within the first subset of battery cells;
determining, based at least in part on the one or more measurements, that the first subset of battery cells is to be disconnected; and
in response to determining to disconnect the first subset of battery cells, disconnecting the first subset of battery cells from at least the second subset of battery cells.

19. The method of claim 18, wherein the one or more measurements indicate a status of the at least one battery cell, and wherein the first subset of battery cells is determined to be disconnected when the status of the at least one battery cell comprises one or more of fully charged, fully discharged, and failed

20. A battery pack, comprising:
a first subset of battery cells;
a second subset of battery cells;
a distributed battery management system, comprising:
at least one sensor configured to take measurements with respect to a plurality of battery cells within the first subset of battery cells; and
a first battery management node configured to perform operations comprising:
receiving, from the at least one sensor, one or more measurements with respect to at least one of the plurality of battery cells within the first subset of battery cells;
determining, based at least in part on the one or more measurements, that the first subset of battery cells is to be disconnected; and
in response to determining to disconnect the first subset of battery cells, disconnecting the first subset of battery cells from the second subset of battery cells; and
a printed circuit board adapted to provide a plurality of interconnections amongst the first subset of battery cells, the second subset of battery cells, and the distributed battery management system.
